(19) United States
(12) Patent Application Publication
(10) Pub. No.: US 2004/0035823 A1
(43) Pub. Date: Feb. 26, 2004

(54) Monolithic ink-jet printhead and method of manufacturing the same

(75) Inventors: Jae-Sik Min, Gyeonggi-do (KR); Byung-Ha Park, Gyeonggi-do (KR); Myung-Jong Kwon, Gyeonggi-do (KR); Young-Shik Park, Gyeonggi-do (KR); Yun-Gi Kim, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG Electronics Co., Ltd.

(21) Appl. No.: 10/422,824

(22) Filed: Apr. 25, 2003

(30) Foreign Application Priority Data
Aug. 26, 2002 (KR) 2002-50527

(51) Int. Cl. G11B 5/127; G01D 15/00

(52) U.S. Cl. 216/27

(57) ABSTRACT

An ink-jet printhead and a method of manufacturing the same include a substrate on which a heater and a passivation layer protecting the heater are formed, a passage plate on which an ink chamber corresponding to the heater and an ink passage connected to the ink chamber are formed, and a nozzle plate in which an orifice corresponding to the ink chamber is formed. An exposure stop layer (ESL) that blocks passage of a photosensitive energy is formed inside the nozzle plate, and the nozzle plate and the passage plate are bonded with each other by the exposure stop layer (ESL).

### CROSS-REFERENCE TO RELATED APPLICATIONS

This application claims the priority of Korean Patent Application No. 2002-50527, filed on Aug. 26, 2002, in the Korean Intellectual Property Office, the disclosure of which is incorporated herein in its entirety by reference.

### BACKGROUND OF THE INVENTION

1. Field of the Invention

The present invention relates to a monolithic ink-jet printhead and a method of manufacturing the same, and more particularly, to a monolithic ink-jet printhead in which an ink chamber and a nozzle are effectively and easily formed, and a method of manufacturing the same.

2. Description of the Related Art

In general, ink-jet printheads eject ink droplets using an electro-thermal transducer (ink-jet type), which generates bubbles in ink using a heat source.

FIG. 1 is a schematic perspective view illustrating a structure of a conventional ink-jet printhead, and FIG. 2 is a schematic cross-sectional view of the ink-jet printhead shown in FIG. 1. Referring to FIGS. 1 and 2, the ink-jet printhead includes a manifold (not shown) to which ink is supplied, a substrate 1 on which a heater 12 and a passivation layer 11 protecting the heater 12 are formed, a passage plate 2 which includes an ink passage 22 and an ink chamber 21 formed on the substrate 1, and a nozzle plate 3 which is formed on the passage plate 2 and has an orifice 31 corresponding to the ink chamber 21.

In general, the passage plate 2 and the nozzle plate 3 are formed by a photolithography process using polyimide. In the conventional ink-jet printhead, the passage plate 2 and the nozzle plate 3 are formed of the same material, for example, the polyimide. The nozzle plate 3 may be easily detached from the passage plate 2 due to a weak adhering property of the polyimide.

In order to solve this problem, in a conventional method of manufacturing the ink-jet printhead, when the passage plate 2 and the nozzle plate 3 are formed of the polyimide as separate layers as described above, the passage plate 2 and the nozzle plate 3 are separately formed from the substrate 1 and are bonded on the substrate 1. In this method, due to several problems including a structural misalignment, the nozzle plate 3 cannot be attached to the substrate, such as a wafer, and the nozzle plate 3 should be attached to each chip which is separated from the wafer. Thus, this method results in low productivity.

Meanwhile, in conventional methods of manufacturing an ink-jet printhead disclosed in U.S. Pat. Nos. 5,524,784 and 6,022,482, a mold layer is used as a sacrificial layer so as to form an ink chamber and an ink passage.

In the conventional methods, the sacrificial layer is formed of a photoresist on a substrate to correspond to patterns of the ink chamber and the ink passage, polyimide is coated to a predetermined thickness on the sacrificial layer, and a passage plate and a nozzle plate are formed as a single body. Then, an orifice (nozzle) is formed in the nozzle plate, and the sacrificial layer is finally removed such that the ink chamber and the ink passage are formed below the nozzle plate. In the conventional methods of forming the ink passage and the orifice (nozzle) using the mold layer, the passage plate and the nozzle plate are formed of the polyimide to protect the mold layer. However, they cannot be hard-baked at a sufficient temperature since the mold layer is formed of the photoresist having a low heat-resistant property. As far as the mold layer exists, the passage plate or the nozzle plate formed of the polyimide cannot be hard-baked. Likewise, the non-hard-baked passage plate or nozzle plate is damaged by an etchant when the mold layer used to form the ink passage and the ink chamber is removed. In particular, a portion where the passage plate contacts the nozzle plate is etched, and an interface between the passage plate and the nozzle plate are damaged by the etchant and become unstable, thereby getting loose from the substrate.

### SUMMARY OF THE INVENTION

The present invention provides a monolithic ink-jet printhead in which a nozzle plate and a passage plate are stably stacked, and a method of manufacturing the same.

The present invention further provides a monolithic ink-jet printhead in which an ink passage and an ink chamber are easily and effectively formed on a substrate, and a method of manufacturing the same.

Additional aspects and advantages of the invention will be set forth in part in the description which follows and, in part, will be obvious from the description, or may be learned by practice of the invention.

According to one aspect of the present invention, an ink-jet printhead includes a substrate on which a heater and a passivation layer protecting the heater are formed, a passage plate in which an ink chamber corresponding to the heater and an ink passage connected to the ink chamber are formed, and a nozzle plate in which an orifice corresponding to the ink chamber is formed. An exposure stop layer (ESL) blocking passage of a photosensitive energy is formed inside the nozzle plate or between the nozzle plate and the passage plate, and the nozzle plate and the passage plate bond by the exposure stop layer (ESL).

According to another aspect of the present invention, the passage plate and the nozzle plate are formed of polyimide. According to another aspect of the present invention, the ESL is formed of a material different from that of the passage plate and the nozzle plate. According to another aspect of the present invention, the ESL is formed of a metal.

According to another aspect of the present invention, a method of manufacturing an ink-jet printhead includes preparing a substrate on which a heater and a passivation layer protecting the heater, coating a first photosensitive photoresist on the substrate to form a passage plate, exposing the passage plate to light through a reticle having a predetermined pattern to optically determine a portion of the passage plate to be removed from the passage plate using a predetermined etchant so as to form an ink chamber corresponding to the heater and an ink passage connected to the ink chamber and to determine a remaining portion of the passage plate to form a wall defining the ink chamber, forming an exposure stop layer (ESL) that intercepts ultraviolet rays, on the passage plate to a predetermined thickness, coating a second photoresist on the exposure stop layer (ESL) to a predetermined thickness to form a nozzle plate, forming an orifice corresponding to the ink chamber in the nozzle plate by a photolithography process, and removing a part of the exposure stop layer (ESL) corresponding to the orifice and a region of the passage plate corresponding to the portion of the passage plate to be removed from the passage plate so as to form the ink chamber and the ink passage.

The passage plate and the nozzle plate are formed of either a negative-type photoresist or a negative-type polyimide. According to another aspect of the present invention, the exposure stop layer (ESL) is formed of a photoresist different from that of the passage plate and the nozzle plate. According to another aspect of the present invention, the exposure stop layer (ESL) is formed of metal. It is possible that the passage plate and the nozzle plate are formed of either the negative-type photoresist or the negative-type polyimide. In particular, after the part of the exposure stop layer (ESL) has been removed, the method further includes performing a flood exposure process on a top surface of the nozzle plate and hard-baking the passage plate and the nozzle plate.

Meanwhile, the method further includes forming an ink supply hole, through which ink is supplied to a top side of the substrate from a bottom side of the substrate. The method further includes forming an ink supply channel, which supplies the ink to the ink chamber through the ink passage and the ink supply hole and has a bottom in which an ink supply hole connected to the ink passage is to be formed, on the bottom surface of the substrate to a predetermined depth.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a schematic perspective view illustrating a structure of a conventional ink-jet printhead;

FIG. 2 is a schematic cross-sectional view of the ink-jet printhead shown in FIG. 1;

FIG. 3 is a schematic plane view illustrating an ink-jet printhead according to an embodiment of the present invention;

FIG. 4 is a cross-sectional view taken along a line X-X of FIG. 3;

FIG. 5 is a cross-sectional view taken along a line Y-Y of FIG. 3; and

FIGS. 6A through 6H are process views illustrating a method of manufacturing the ink-jet printhead shown in FIGS. 3 through 5.

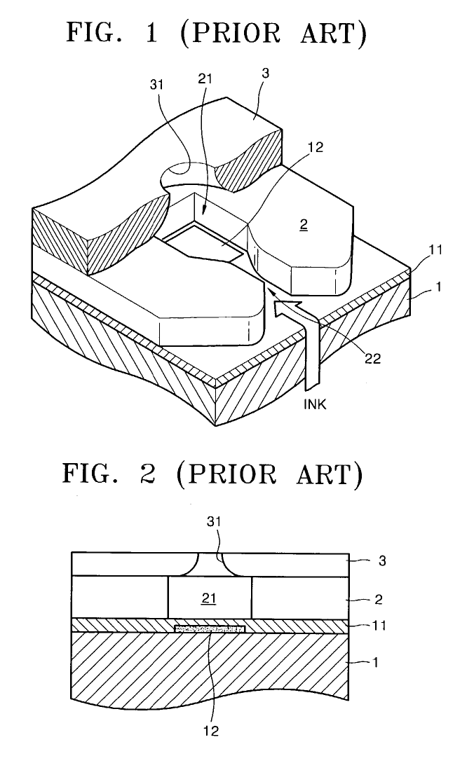

### DETAILED DESCRIPTION OF THE PREFERRED EMBODIMENTS

Reference will now be made in detail to the present preferred embodiment of the present invention, examples of which are illustrated in the accompanying drawings, wherein like reference numerals refer to the like elements throughout. The embodiment is described in order to explain the present invention by referring to the figures.

Hereinafter, an ink-jet printhead and a method of manufacturing the same according to an embodiment of the present invention will be described in detail with reference to the accompanying drawings.

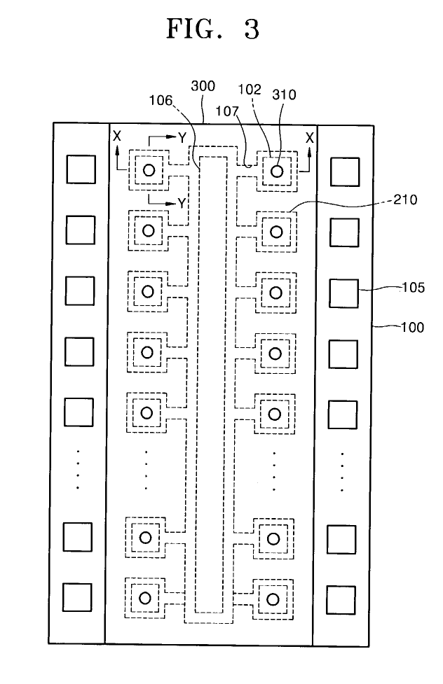

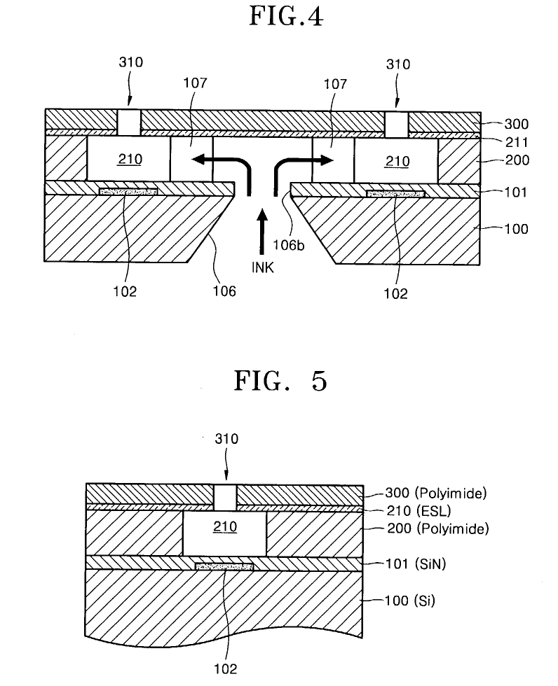

FIG. 3 is a schematic plane view illustrating an inkjet printhead according to an embodiment of the present invention, FIG. 4 is a cross-sectional view taken along a line X-X of FIG. 3, and FIG. 5 is a cross-sectional view taken along a line Y-Y of FIG. 3.

As shown in FIG. 3, a plurality of pads 105 to be electrically connected to an internal circuit of the ink-jet printhead are arranged in a line along both long sides of a substrate 100 of the ink-jet printhead. The pads 105 may be formed along short sides of the substrate 100 according to design specifications. A nozzle plate 300 is placed between both edges (long or short sides) of the substrate 100 on which the pads 105 are formed. As shown in FIGS. 4 and 5, an orifice 310 through which ink droplets are ejected is formed in the nozzle plate 300, and a heater 102 formed on a top surface of the substrate 100 is placed on a bottom of an ink chamber 210 below the nozzle plate 300. The heater 102 is protected by a passivation layer 101. The heater 102 is electrically connected to the pads 105. As shown in FIGS. 3 through 5, the heater 102 is to be formed in the ink chamber 210 determined (defined) by a passage plate 200. The ink chamber 210 is connected to an ink supply channel 106 through an ink supply hole 106b formed in the substrate 100 by an ink passage 107. In the present embodiment, the nozzle plate 300 and the passage plate 200 are formed of a photoresist, in particular, polyimide.

Referring to FIGS. 4 and 5, an exposure stop layer (ESL) 211, which is a feature of the present invention, is formed on a bottom surface of the nozzle plate 300. The ESL 211 may be formed of a dyed photoresist so as to intercept metals, such as Ni and Ti, or an exposure energy, such as ultraviolet rays and an X-ray. Here, the ESL 211 reflects and/or absorbs incident ultraviolet rays or X-ray, thereby preventing the exposure energy from transmitting to the passage plate 200 from an outside of the nozzle plate 300. Besides the above-described exposure stop function, the ESL 211 improves an adhesive force between the nozzle plate 300 and the passage plate 200 formed of a material, such as the polyimide, having a weak adhering property. On the other hand, the ESL 211 plays a very important role in manufacturing the passage plate 200 and the nozzle plate 300. A method of manufacturing the ink-jet printhead using another function of the ESL 211 in manufacturing the passage plate 200 and the nozzle plate 300, will be described in detail with reference to the accompanying drawings.

Hereinafter, well-known techniques, in particular, well-known techniques for manufacturing portions of the ink-jet printhead will not be specifically described.

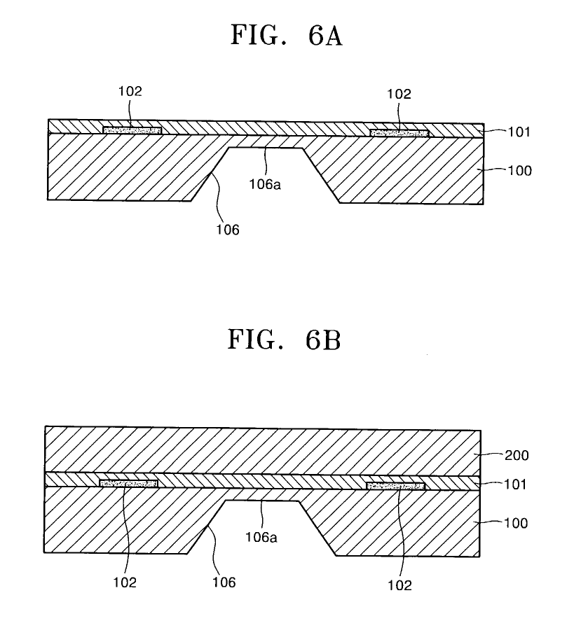

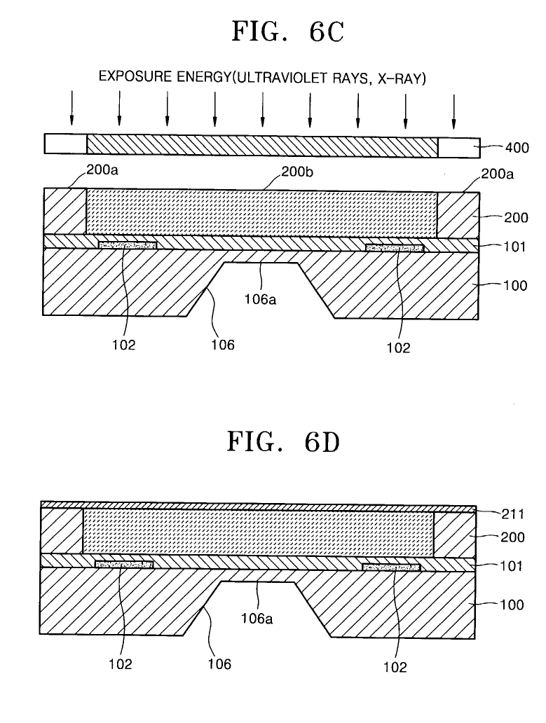

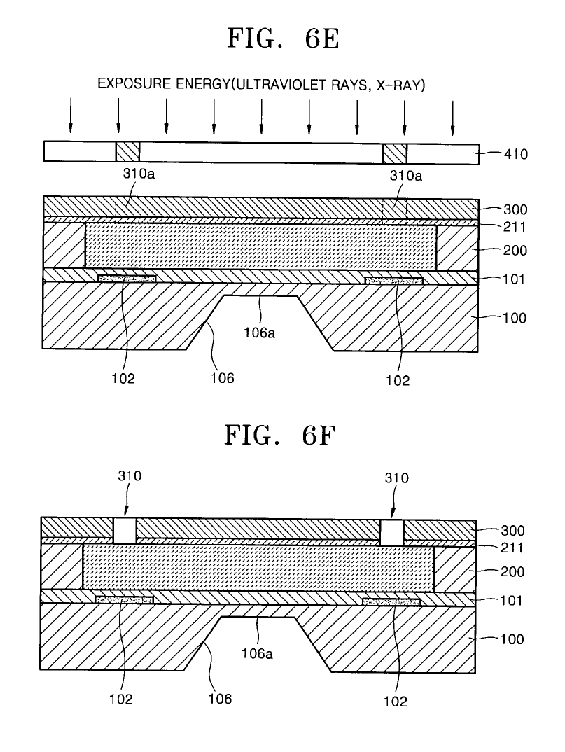

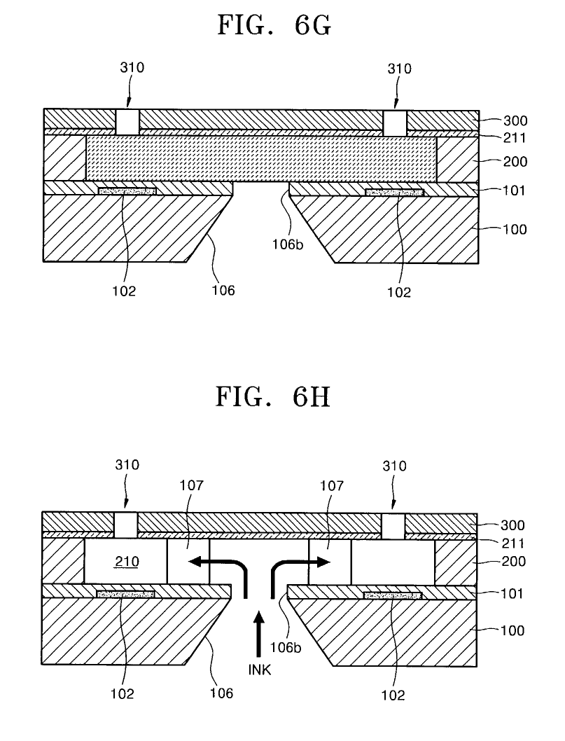

FIGS. 6A through 6H are process views illustrating a method of manufacturing the inkjet printhead, and the process views correspond to a cross-section taken along line X-X of FIG. 3.

As shown in FIG. 6A, the substrate 100, such as a silicon wafer or a single monolithic silicon wafer, on which an underlayer including the heater 102 and the passivation layer 101 made of SiN to protect the heater 102 is formed, is prepared. This operation is performed on the wafer and accompanies forming a material for use in the heater 102, patterning the formed material to form the heater 102, and depositing the passivation layer 101 on the heater 102 and the substrate 100. The ink supply channel 106 supplying ink is formed on a bottom of the substrate 100. In this case, a bottom 106a of the ink supply channel 106 is placed between the heaters 102 installed on the substrate 100 and is perforated by a subsequent process. Here, the ink supply channel 106 may be not formed in the above-described operation but may be formed after the nozzle plate 300 is formed.

As shown in FIG. 6B, the photoresist, for example, the polyimide, is coated to a thickness of several microns, for example, to a thickness of 30 microns, on an entire surface of the passivation layer 101 formed on the substrate 100 to form the passage plate 200. Here, a positive-type or negative-type photoresist or polyimide may be used as the passage plate 200.

As shown in FIG. 6C, the passage plate 200 is exposed to the exposure energy using a predetermined pattern. In this case, an exposure process is performed using a reticle 400 such as a metal mask. The reticle 400 has a pattern used to optically determine (define) a portion 200b, which is to be removed from the passage plate 200 using a predetermined etchant so as to form the ink chamber 210 corresponding to the heater 102 and the ink passage 107 connected to the ink chamber 210, and to optically determine (define) a remaining portion 200a of the passage plate 200 to form a wall defining the ink chamber 210. In this embodiment, the passage plate 200 is formed of the negative-type polyimide. Here, when the passage plate 200 is formed of the negative-type photoresist or polyimide, the remaining portion 200a is exposed. Contrarily, when the passage plate 200 is formed of the positive-type photoresist or polyimide, the portion 200b is exposed.

As shown in FIG. 6D, the exposure stop layer (ESL) 211, which intercepts and absorbs a photosensitive energy (exposure energy), such as the ultraviolet rays or the X-ray, and prevents the photosensitive energy from transmitting to the passage plate 200, is formed to a predetermined thickness on the passage plate 200. A dyed photoresist, used to intercept and absorb the metals, such as Ni and Ti, or the photosensitive energy, may be used as the ESL 211. When the ESL 211 is formed of the photoresist, it is possible that the ESL 211 is formed of a material different from that of the passage plate 200.

As shown in FIG. 6E, the nozzle plate 300 is formed on a top surface of the ESL 211 by spin-coating the photoresist or the polyimide to a predetermined thickness. Subsequently, the nozzle plate 300 is exposed using a predetermined pattern. In this case, a second reticle 410, such as the metal mask, having a pattern corresponding to a shape of the orifice 310 formed on the nozzle plate 300, is used during another exposure process. In the exposure process, a light energy is intercepted by the ESL 211 on the passage plate 200 below the nozzle plate 300, and thus, the passage plate 200 is not exposed. FIG. 6E shows a case where the negative-type polyimide is used and a portion excluding an orifice-forming portion 310a is exposed.

As shown in FIG. 6F, the orifice-forming portion 310a is etched to form the orifice 310. In this case, when the ESL 211 is formed of the polyimide or the photoresist, a part of the ESL 211 that blocks an internal side of the orifice 310, is removed. Thus, a surface of the portion 200b of the passage plate 200 is exposed through a lower portion of the orifice 310. Also, when the ESL 211 is formed of metal, a part of the ESL 211 that blocks the orifice 310, is removed by a separate etch process using the orifice 310.

As shown in FIG. 6G, the ink supply hole 106b which penetrates the substrate 100, is formed using an XeF₂ dry etch process by removing the bottom 106a of the ink supply channel 106. Thus, an ink supply route through which ink is supplied to a top surface of the substrate 100 from a bottom surface of the substrate 100 is formed on the substrate 100. In this case, when the ink supply channel 106 is not formed on the bottom surface of the substrate 100 in the operation shown in FIG. 6A, the ink supply channel 106 and the ink supply hole 106b are formed together on the substrate 100.

As shown in FIG. 6H, the portion 200b to be removed from the passage plate 200 is removed through the orifice 310 and the ink supply channel 106. In this case, an etchant is supplied through the orifice 310 and the ink supply channel 106, and the ink chamber 210 and the ink passage 107 are formed in the passage plate 200 through an etch process.

After the ink chamber 210 and the ink passage 107 are formed in the passage plate 200, a flood exposure process is performed on the top surface of the substrate 100 such that the passage plate 200 and the nozzle plate 300 are more light-cured. Subsequently, the passage plate 200 and the nozzle plate 300 are hard-baked, thereby manufacturing a desired ink-jet printhead. Here, the flood exposure process is used when light-cured, that is, the negative-type photoresist and polyimide are used as the nozzle plate 300 and the passage plate 200. Likewise, it is possible that the passage plate 200 and the nozzle plate 300 are formed of a negative-type material.

As described above, according to the present invention, the passage plate and the nozzle plate can be formed by a simpler process than the related art while being maintained at a separate body. In particular, a region for the passage plate itself is optically determined such that an additional mold layer for obtaining the ink chamber and the ink passage like in the related art is not required. In addition, the exposure stop layer used in manufacturing the nozzle plate and the passage plate prevents exposure of the passage plate, remains in a structure of the ink-jet printhead, and helps a stable adhesion between the passage plate and the nozzle plate.

While this invention has been particularly shown and described with reference to preferred embodiments thereof, it will be understood by those skilled in the art that various changes in form and details may be made therein without departing from the spirit and scope thereof as defined by the appended claims and their equivalents.

What is claimed is:

1. An inkjet printhead comprising:
a substrate on which a heater and a passivation layer protecting the heater are formed;
a passage plate in which an ink chamber corresponding to the heater and an ink passage connected to the ink chamber are formed; and
a nozzle plate in which an orifice corresponding to the ink chamber is formed;
wherein an exposure stop layer (ESL) that blocks passage of a photosensitive energy is formed between the passage plate and the nozzle plate, and the nozzle plate and the passage plate are bonded with each other by the exposure stop layer (ESL).

2. The printhead of claim 1, wherein the passage plate and the nozzle plate are formed of polyimide.

3. The printhead of claim 2, wherein the ESL is formed of a material different from the passage plate and the nozzle plate.

4. The printhead of claim 1, wherein the ESL is formed of a material different from those of the passage plate and the nozzle plate.

5. The printhead of claim 1, wherein the ESL is formed of a metal.

6. A method of manufacturing an ink-jet printhead, the method comprising:
forming a heater and a passivation layer protecting the heater on a substrate;
coating a first photosensitive photoresist on the substrate to form a passage plate;
exposing the passage plate to light using a reticle having a predetermined pattern to optically determine a portion of the passage plate to be removed from the passage plate using a predetermined etchant so as to form an ink chamber corresponding to the heater and an ink passage connected to the ink chamber, and to determine a remaining portion of the passage plate;
forming an exposure stop layer (ESL) that intercepts ultraviolet rays, on the passage plate to a predetermined thickness;
coating a second photoresist on the exposure stop layer (ESL) to a predetermined thickness to form a nozzle plate;
forming an orifice corresponding to the ink chamber in the nozzle plate by a photolithography process; and
removing a part of the exposure stop layer (ESL) corresponding to the orifice and a region of the passage plate selected as the portion to be removed from the passage plate so as to form the ink chamber and the ink passage.

7. The method of claim 6, wherein the exposure stop layer (ESL) is formed of a photoresist different from that of the passage plate and the nozzle plate.

8. The method of claim 6, wherein the exposure stop layer (ESL) is formed of metal.

9. The method of claim 8, wherein the passage plate and the nozzle plate are formed of either a negative-type photoresist or a negative-type polyimide.

10. The method of claim 9, wherein the removing of the part of the exposure stop layer (ESL) and the region of the passage plate comprises:
performing a flood exposure process on a top surface of the nozzle plate; and
hard-baking the passage plate and the nozzle plate.

11. The method of claim 6, further comprising:
forming an ink supply hole through which ink is supplied to a bottom surface of the substrate.

12. The method of claim 6, further comprising:
forming an ink supply channel, which supplies ink to the ink chamber through the ink passage and has an ink supply hole formed on the passivation layer to be connected to the ink passage, on a bottom surface of the substrate to a predetermined depth.

13. The method of claim 6, wherein the passage plate and the nozzle plate are formed of either a negative-type photoresist or a negative-type polyimide.

14. The method of claim 13, wherein the exposure stop layer (ESL) is formed of the photoresist different from that of the passage plate and the nozzle plate.

15. The method of claim 13, wherein the exposure stop layer (ESL) is formed of a metal.

16. The method of claim 15, wherein the passage plate and the nozzle plate are formed of either a negative-type photoresist or a negative-type polyimide.

17. The method of claim 16, wherein the removing of the part of the exposure stop layer (ESL) and the region of the passage plate comprises:
performing a flood exposure process on a top surface of the nozzle plate; and
hard-baking the passage plate and the nozzle plate.

18. The method of claim 13, further comprising:
forming an ink supply hole through which ink is supplied to a bottom surface of the substrate.

19. The method of claim 13, further comprising:
forming an ink supply channel, which supplies ink to the ink chamber through the ink passage and has a bottom in which an ink supply hole connected to the ink passage is to be formed, on the bottom surface of the substrate to a predetermined depth.

20. An ink-jet printhead comprising:
a substrate on which a plurality of heaters and a passivation layer protecting the heaters are formed, and in which an ink supply channel is formed;
a passage plate formed on the substrate and having a plurality of ink chambers corresponding to the respective heater and a plurality of ink passages connecting the ink supply channel to corresponding ones of the ink chambers; and
a nozzle plate formed on the passage plate and having a plurality of orifices corresponding to the respective ink chambers;
wherein an exposure stop layer (ESL) having an exposure stop function and a bonding characteristic is formed between the passage plate and the nozzle plate to block a photosensitive energy and bond the nozzle plate and the passage plate.

21. The printhead of claim 20, wherein the substrate comprises:
a single monolithic wafer.

22. The printhead of claim 20, wherein the passivation layer is formed on the heaters and the substrate which is not covered by the heaters.

23. The printhead of claim 20, wherein the passivation layer comprises a single monolithic body, and the passage plate is formed on the passivation layer.

24. The printhead of claim 20, wherein the heaters are arranged in a first line and a second line disposed on both sides of the substrate, and the ink supply channel is disposed between the first line and the second line.

25. The printhead of claim 24, wherein the ink chambers are arranged along corresponding ones of the first and second lines to be coupled to corresponding ones of the heaters, and the ink supply channel comprises:
first and second sub-ink supply channels disposed to correspond to the respective ink chambers through the respective ink passages.

26. The printhead of claim 25, wherein the first and second sub-ink supply channels are disposed to be parallel to each other and the first and second lines, and the ink supply channel comprises:
a third sub-ink supply channel coupled between the first and second sub-ink supply channels.

27. The printhead of claim 24, wherein the ink supply channel narrows toward the passivation layer from an outside of the substrate.

28. The printhead of claim 20, wherein the substrate comprises:
a first side on which the ink passages and the heaters are formed; and
a second side on which the ink supply channel is formed.

29. The printhead of claim 20, further comprising:
a plurality of pads connected to corresponding ones of the heaters.

30. The printhead of claim 20, wherein the ESL comprises:
a plurality of parts corresponding to the respective orifices.

31. The printhead of claim 30, wherein the parts of the ESL have the same diameter as the corresponding ones of the respective orifices.

32. The printhead of claim 30, wherein the parts of the ESL couples the ink chambers to corresponding ones of the orifices.

33. The printhead of claim 30, wherein the orifices of the nozzle plate, the parts of the ESL, and the ink chambers of the passage plate are arranged in a line.

34. The printhead of claim 30, wherein the orifices of the nozzle plate, the parts of the ESL, and the ink chambers of the passage plate are disposed on a common center line.

35. The printhead of claim 34, wherein the common center line is perpendicular to a major heating surface of the corresponding heater.

36. A method of manufacturing an ink-jet printhead, the method comprising:
forming a plurality of heaters and a passivation layer protecting the heaters on a first side of a substrate;
forming an ink supply channel on a second side of the substrate;
forming a passage plate on the passivation layer to form a plurality of ink chambers corresponding to the respective heater and a plurality of ink passages connecting the ink supply channel to corresponding ones of the ink chambers;
forming an exposure stop layer (ESL) on the passage plate; and
forming a nozzle plate having a plurality of orifices corresponding to the respective ink chambers on the ESL;
wherein the ESL blocks passage of a photosensitive energy between the passage plate and the nozzle plate and bonds the nozzle plate and the passage plate.

37. The method of claim 36, wherein the forming of the passage plate comprises:
exposing the passage plate to light using a reticle having a predetermined pattern.

38. The method of claim 37, wherein the exposing of the passage plate to the light comprises:
optically determining a plurality of portions of the passage plate to be removed from the passage plate using a predetermined etchant to form the ink chambers, and to optically determine the ink passages connected to the ink chamber.

39. The method of claim 37, wherein the exposing of the passage plate to the light comprises:
determining a remaining portion of the passage plate corresponding to walls defining corresponding ones of the ink chambers.

40. The method of claim 37, wherein the exposing of the passage plate to the light comprises:
removing the portions of the passage plate from the passage plate using an echant through the orifices.

41. The method of claim 40, wherein the removing of the portions of the passage plate comprises:
removing portions of the nozzle plate and the ESL from the nozzle plate and the ESL, respectively to form the orifices.

42. The method of claim 36, wherein the forming of the nozzle plate comprises:
exposing the nozzle plate to light using a reticle having a predetermined pattern corresponding to the orifices.

43. The method of claim 42, wherein the exposing of the nozzle plate to the light comprises:
removing portions of the nozzle plate from the nozzle plate to form the orifices.

44. The method of claim 42, wherein the exposing of the nozzle plate to the light comprises:
removing parts of the ESL from the ESL to form the orifices.

45. The method of claim 42, wherein the forming of the nozzle plate comprises:
hard-baking the passage plate and the nozzle plate.

46. A method of manufacturing an ink-jet printhead, the method comprising:
forming a heater and a passivation layer protecting the heater on a substrate;
forming a passage plate in which an ink chamber corresponding to the heater and an ink passage connected to the ink chamber are formed, on the passivation layer of the substrate;
forming an exposure stop layer (ESL) on the passage plate; and
forming a nozzle plate in which an orifice corresponding to the ink chamber is formed, on the ESL;
wherein the ESL blocks passage of a photosensitive energy and bonds the nozzle plate and the passage plate.
